(19) United States
(12) Patent Application Publication
(10) Pub. No.: US 2026/0160608 A1
(43) Pub. Date: Jun. 11, 2026

(54) SENSOR APPARATUS AND METHOD OF MANUFACTURING SENSOR APPARATUS

(71) Applicant: TDK CORPORATION, Tokyo (JP)

(72) Inventors: Yusuke Kimoto, Tokyo (JP); Tadao Senriuchi, Tokyo (JP); Shinji Hara, Tokyo (JP)

(73) Assignee: TDK CORPORATION, Tokyo (JP)

(21) Appl. No.: 19/328,957

(22) Filed: Sep. 15, 2025

(30) Foreign Application Priority Data
Sep. 24, 2024 (JP) 2024-165455
Jun. 23, 2025 (JP) 2025-105864

(51) Int. Cl. G01K 7/24

(52) U.S. Cl. CPC G01K 7/24

(57) ABSTRACT

A sensor apparatus includes: one or more first wirings; second wirings; one or more first impedance elements; one or more second impedance elements; one or more first converter circuits each converting a first current flowing through one of the second wirings into a first voltage; a second converter circuit converting a second current flowing through one of the second wirings into a second voltage; one or more first amplifier circuits each outputting a first amplified voltage resulting from amplifying the first voltage, a second amplifier circuit outputting a second amplified voltage resulting from amplifying the second voltage, or both of the first and second amplifier circuits; and a subtractor circuit outputting at least one of a difference between the first amplified voltage and the second amplified voltage, a difference between the first amplified voltage and the second voltage, or a difference between the first voltage and the second amplified voltage.

### CROSS-REFERENCE TO RELATED APPLICATIONS

The present application claims priority from Japanese Patent Application No. 2024-165455 filed on Sep. 24, 2024 and Japanese Patent Application No. 2025-105864 filed on Jun. 23, 2025, the entire contents of each of which are hereby incorporated by reference.

### BACKGROUND

The disclosure relates to a sensor apparatus including multiple impedance elements, and to a method of manufacturing such a sensor apparatus.

A resistor array circuit has been proposed that includes multiple resistors arranged in a matrix. Such a resistor array circuit is used as, for example, an infrared detection circuit. For example, reference is made to Japanese Unexamined Patent Application Publication No. H08-094443. Such an infrared detection circuit includes infrared-sensitive resistors arranged therein. Examples of the infrared-sensitive resistors may include a thermistor whose resistance value changes with changing temperature.

### SUMMARY

A sensor apparatus according to one embodiment of the disclosure includes: one or more first wirings; second wirings; one or more first impedance elements; one or more second impedance elements; one or more first converter circuits; a second converter circuit; one or more first amplifier circuits, a second amplifier circuit, or both; and a subtractor circuit. The second wirings each extend in a direction different from a direction in which the one or more first wirings each extend. The one or more first impedance elements are each coupled to both corresponding one of the one or more first wirings and corresponding one of the second wirings. The one or more second impedance elements are each coupled to both corresponding one of the one or more first wirings and corresponding one of the second wirings. The one or more first converter circuits are each configured to convert a first current into a first voltage. The first current flows through corresponding one, of the second wirings, to which one or more of the one or more first impedance elements are each coupled. The second converter circuit is configured to convert a second current into a second voltage. The second current flows through corresponding one, of the second wirings, to which the one or more second impedance elements are each coupled. The one or more first amplifier circuits are each configured to output a first amplified voltage resulting from amplifying the first voltage corresponding to each of corresponding one or more first impedance elements, out of the one or more first impedance elements, at a first gain corresponding to relevant one of the corresponding one or more first impedance elements. The second amplifier circuit is configured to output a second amplified voltage resulting from amplifying the second voltage corresponding to each of the one or more second impedance elements at a second gain corresponding to relevant one of the one or more second impedance elements. The subtractor circuit is configured to output at least one of a difference between the first amplified voltage and the second amplified voltage, a difference between the first amplified voltage and the second voltage, or a difference between the first voltage and the second amplified voltage.

A method of manufacturing a first sensor apparatus according to one embodiment of the disclosure includes:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled; and
determining a first gain and a second gain, or determining the first gain, the first gain corresponding to, out of the one or more first impedance elements, each of certain one or more first impedance elements coupled to one first wiring out of the one or more first wirings, the second gain corresponding to, out of the one or more second impedance elements, one second impedance element coupled to the one first wiring, to allow a difference between a first amplified voltage and the second voltage or a difference between the first amplified voltage and a second amplified voltage to have a value that falls within a predetermined range and that depends on none of the one or more first impedance elements and none of the one or more second impedance elements, where the first amplified voltage results from amplifying the first voltage corresponding to each of the certain one or more first impedance elements coupled to the one first wiring at the first gain corresponding to relevant one of the certain one or more first impedance elements, the second voltage corresponds to the one second impedance element coupled to the one first wiring, and the second amplified voltage results from amplifying the second voltage corresponding to the one second impedance element coupled to the one first wiring at the second gain corresponding to the one second impedance element.

A method of manufacturing a second sensor apparatus according to one embodiment of the disclosure includes:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled; and
determining a second gain corresponding to, out of the one or more second impedance elements, one second impedance element coupled to one first wiring out of the one or more first wirings, to allow a difference between the first voltage and a second amplified voltage to have a value that falls within a predetermined range and that depends on none of the one or more first impedance elements and none of the one or more second impedance elements, where the first voltage corresponds to, out of the one or more first impedance elements, each of certain one or more first impedance elements coupled to the one first wiring out of the one or more first wirings, and the second amplified voltage results from amplifying the second voltage corresponding to the one second impedance element coupled to the one first wiring at the second gain corresponding to the one second impedance element.

A method of manufacturing a third sensor apparatus according to one embodiment of the disclosure includes:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled;
determining a second gain corresponding to, out of the one or more second impedance elements, one second impedance element coupled to one first wiring out of the one or more first wirings, to allow a difference between the first voltage and a second amplified voltage to have a value that falls within a predetermined range and that depends on none of the one or more first impedance elements and none of the one or more second impedance elements, where the first voltage corresponds to, out of the one or more first impedance elements, one first impedance element coupled to the one first wiring and coupled to one second wiring out of the second wirings, and the second amplified voltage results from amplifying the second voltage corresponding to the one second impedance element coupled to the one first wiring at the second gain corresponding to the one second impedance element; and
determining a first gain corresponding to, out of the one or more first impedance elements, each of certain one or more first impedance elements coupled to the one first wiring and coupled to one or more of the second wirings other than the one second wiring, to allow a difference between a first amplified voltage and the second amplified voltage to have a value that falls within a predetermined range and that depends on none of the one or more first impedance elements and none of the one or more second impedance elements, where the first amplified voltage results from amplifying the first voltage corresponding to each of the certain one or more first impedance elements coupled to the one first wiring and coupled to the one or more of the second wirings other than the one second wiring at the first gain corresponding to relevant one of the certain one or more first impedance elements, and the second amplified voltage is based on the second voltage corresponding to the one second impedance element coupled to the one first wiring.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a functional block diagram illustrating an overall configuration example of a sensor apparatus according to one example embodiment of the disclosure.

FIG. 2 is a circuit diagram illustrating a circuit configuration of each of a detector circuitry and a converter circuitry of the sensor apparatus illustrated in FIG. 1.

FIG. 3 is a circuit diagram illustrating a circuit configuration of each of the converter circuitry, an amplifier circuitry, and a subtractor circuit of the sensor apparatus illustrated in FIG. 1.

FIG. 4 is a circuit diagram illustrating a circuit configuration of each of a converter circuitry, an amplifier circuitry, and a subtractor circuit of a sensor apparatus according to a first modification example of one example embodiment of the disclosure.

FIG. 5 is a circuit diagram illustrating a circuit configuration of each of a converter circuitry, an amplifier circuitry, and a subtractor circuit of a sensor apparatus according to a second modification example of one example embodiment of the disclosure.

FIG. 6 is a circuit diagram illustrating a circuit configuration of each of a detector circuitry and a converter circuitry of a sensor apparatus according to a third modification example of one example embodiment of the disclosure.

### DETAILED DESCRIPTION

What is desired of a sensor apparatus including multiple sensor elements is to achieve high measurement accuracy for a physical quantity targeted for measurement.

It is desirable to provide a sensor apparatus that achieves high measurement accuracy for a physical quantity targeted for measurement, and a method of manufacturing such a sensor apparatus.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

The description is given in the following order.
1. Example embodiment: an example of a sensor apparatus including a first amplifier circuit and a second amplifier circuit
2. Modification examples

### 1. Example Embodiment

### <Overall Configuration Example of Sensor Apparatus>

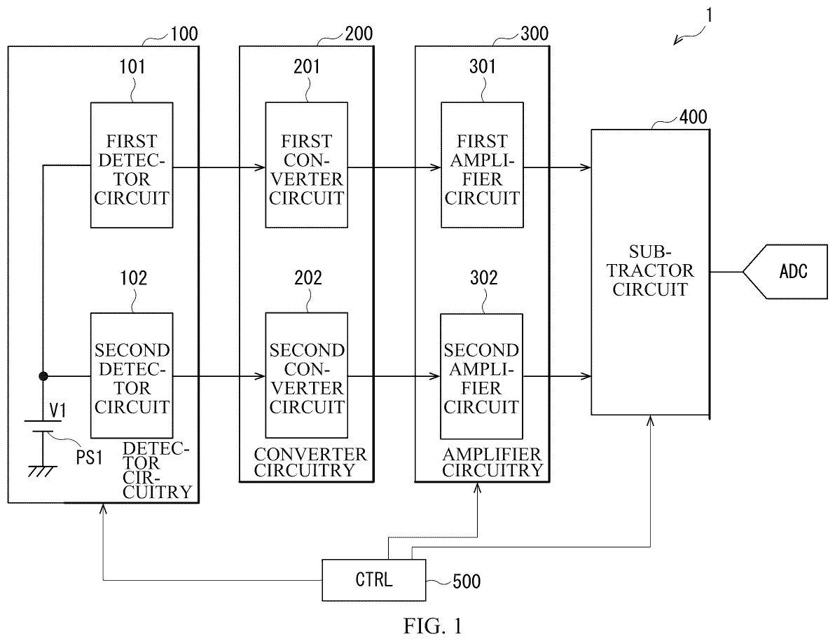

FIG. 1 is a functional block diagram illustrating an overall configuration example of a sensor apparatus 1 according to a first example embodiment of the disclosure. The sensor apparatus 1 may include a detector circuitry 100, a converter circuitry 200, an amplifier circuitry 300, a subtractor circuit 400 as a calculator, and a control processor 500. As illustrated in FIG. 1, the detector circuitry 100 may include a first detector circuit 101 and a second detector circuit 102. The converter circuitry 200 may include a first converter circuit 201 and a second converter circuit 202. The amplifier circuitry 300 may include a first amplifier circuit 301 and a second amplifier circuit 302.

### <Detailed Configuration Example of Sensor Apparatus>

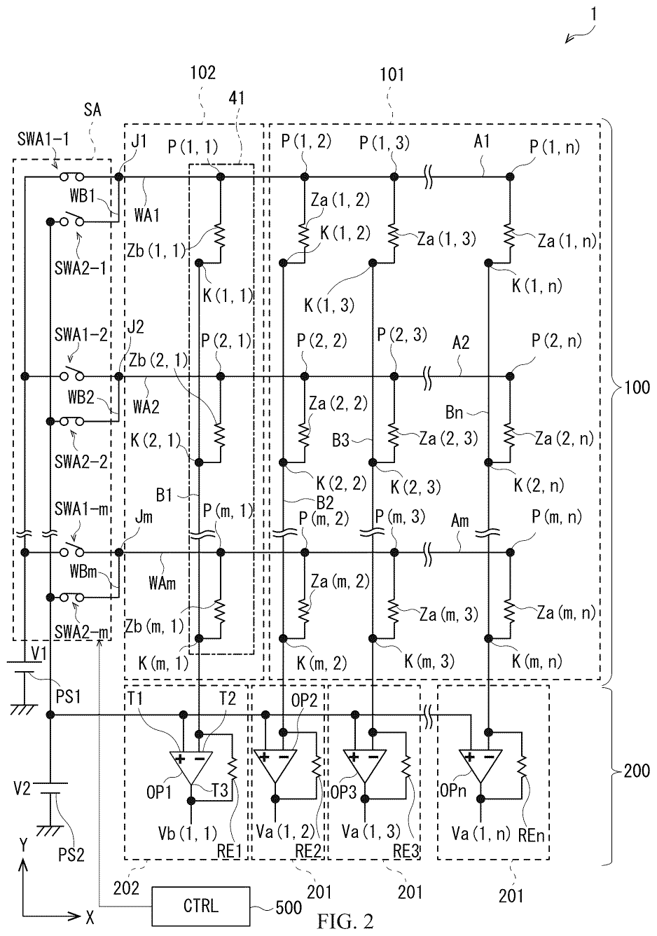

FIG. 2 is a circuit diagram illustrating a detailed circuit configuration example of each of the detector circuitry 100 and the converter circuitry 200 of the sensor apparatus 1 illustrated in FIG. 1. The detector circuitry 100 may be mountable on, for example, an electromagnetic wave sensor (e.g., an infrared thermography) that detects electromagnetic waves, such as infrared rays, and may be configured to output a current corresponding to an intensity of the electromagnetic waves, such as the infrared rays, applied to the detector circuitry 100. The detector circuitry 100 may perform a measurement operation in accordance with a command from the control processor 500. The control processor 500 is also illustrated in FIG. 2.

### <Detector Circuitry 100>

As illustrated in FIG. 2, the detector circuitry 100 may include, for example, one or more power feeding lines A (illustrated as power feeding lines A1 to Am in FIG. 2 by way of example), readout lines B (denoted as B1 to Bn in FIG. 2), one or more resistors Za (illustrated as resistors Za(1, 2) to Za(m, n) in FIG. 2 by way of example), one or more resistors Zb (illustrated as resistors Zb(1, 1) to Zb(m, 1) in FIG. 2 by way of example), and a power feeding line selector SA. The converter circuitry 200 may include operational amplifiers OP (denoted as OP1 to OPn in FIG. 2) and resistors RE (denoted as RE1 to REn in FIG. 2). The converter circuitry 200 will be described in detail later. The resistors Za may be provided in the first detector circuit 101 of the detector circuitry 100. The resistors Zb may be provided in the second detector circuit 102 of the detector circuitry 100. In the second detector circuit 102, an electromagnetic shield 41 may be further provided to cover the resistors Zb. In the sensor apparatus 1, the resistors Zb may thus be used as reference elements to correct measurement errors dependent on an ambient temperature at which the sensor apparatus 1 is placed. In FIG. 2, “m” power feeding lines A are provided by way of example, and the number “m” of the power feeding lines A may be freely chosen from among integers of two or more. Similarly, in FIG. 2, “n” readout lines B are provided by way of example, and the number “n” of the readout lines B may be freely chosen from among integers of two or more. The power feeding lines A and the readout lines B may not be in direct contact with each other.

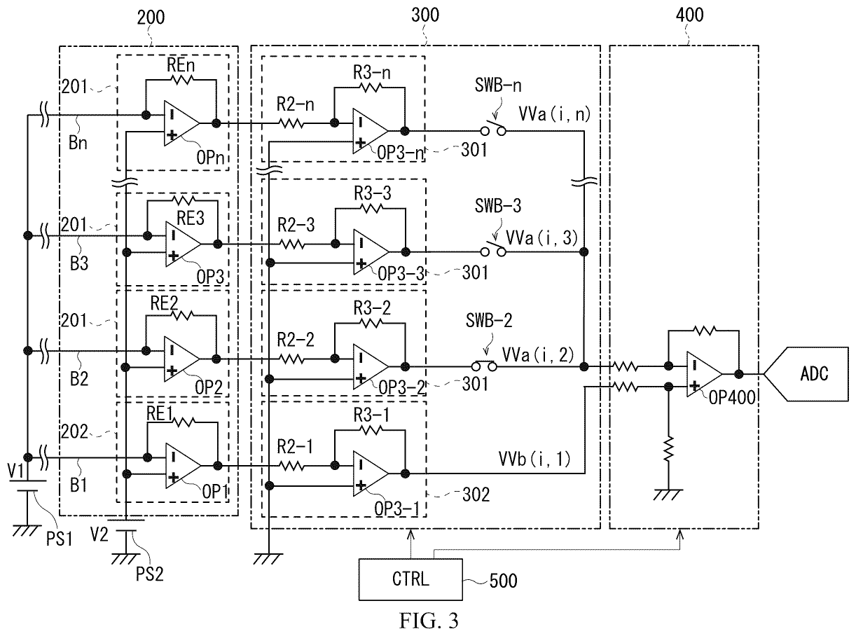

In FIG. 2, one resistor Za coupled to both an “i”-th power feeding line Ai of the “m” power feeding lines A1 to Am and a “j”-th readout line Bj of the “n” readout lines B1 to Bn is denoted as Za(i, j), where “i” is a natural number less than or equal to “m”, and “j” is a natural number greater than or equal to one and less than or equal to “n”. Note that in the example illustrated in FIG. 2, the resistors Za may be coupled to a second to an “n”-th readout lines B2 to Bn of the readout lines B1 to Bn. Further, in FIG. 2, one resistor Zb coupled to both the “i”-th power feeding line Ai of the “m” power feeding lines A1 to Am and the “j”-th readout line Bj of the “n” readout lines B1 to Bn is denoted as Zb(i, j). Definitions of the numbers “i” and “j” are as described above. Note that in the example illustrated in FIG. 2, the resistors Zb may be coupled to only a first readout line B1 of the readout lines B1 to Bn. The same applies to FIG. 3 and subsequent drawings. The resistors Za may each be an active element to be subjected to electromagnetic waves, such as infrared rays, from a measurement target, for example. The resistors Za may correspond to a specific but non-limiting example of “one or more first impedance elements” in one embodiment of the disclosure. The resistors Zb may each be a blind element to be protected by the electromagnetic shield 41 from the electromagnetic waves emitted from the measurement target, for example. The resistors Zb may correspond to a specific but non-limiting example of “one or more second impedance elements” in one embodiment of the disclosure. Hereinafter, each of the resistors Za and Zb may sometimes be collectively referred to as a “resistor Z”.

In FIG. 2, a node P between the “i”-th power feeding line Ai of the “m” power feeding lines A1 to Am and the resistor Z(i, j) is denoted as P(i, j). Further, in FIG. 2, a node K between the “j”-th readout line Bj of the “n” readout lines B1 to Bn and the resistor Z(i, j) is denoted as K(i, j).

### <Power Feeding Line A>

The power feeding lines A may correspond to a specific but non-limiting example of “one or more first wirings” in one embodiment of the disclosure.

The power feeding lines A (A1 to Am in FIG. 2) may each be a conductor extending in a first direction from a node P(i, 1) to a node P(i, n). The first direction may be an X-axis direction. The power feeding lines A may be arranged adjacent to each other in a second direction different from the first direction. The second direction may be a Y-axis direction. In the example illustrated in FIG. 2, the “m” power feeding lines A may each extend in the X-axis direction and may be arranged adjacent to each other in the Y-axis direction orthogonal to the X-axis direction. The power feeding line A1 may extend from a node P(1, 1) to a node P(1, n). The power feeding line A2 may extend from a node P(2, 1) to a node P(2, n). The power feeding line Am may extend from a node P(m, 1) to a node P(m, n).

As illustrated in FIG. 2, the power feeding lines A (A1 to Am) may each have a first end coupled to a direct-current power supply PS1 via corresponding one of coupling wirings WA (denoted as WA1 to WAm in FIG. 2). The coupling wiring WA1 may extend from the direct-current power supply PS1 to the node P(1, 1). The coupling wiring WA2 may extend from the direct-current power supply PS1 to the node P(2, 1). The coupling wiring WAm may extend from the direct-current power supply PS1 to the node P(m, 1). Thus, a coupling wiring WA1 may extend from the direct-current power supply PS1 to the node P(i, 1). Further, coupling wirings WB (denoted as WB1 to WBm in FIG. 2) may each be coupled to corresponding one of the coupling wirings WA (WA1 to WAm). For example, a second end of the coupling wiring WB1 may be coupled to the coupling wiring WA1 at a node J1; a second end of the coupling wiring WB2 may be coupled to the coupling wiring WA2 at a node J2; and a second end of the coupling wiring WBm may be coupled to the coupling wiring WAm at a node Jm. Thus, a second end of a coupling wiring WBi may be coupled to the coupling wiring WA1 at a node J1. Note that the second end of the coupling wiring WBi may be coupled to the coupling wiring WAi at the node P(i, 1). In other words, the node Ji and the node P(i, 1) may be coincident with each other. Further, a first end of the coupling wiring WBi opposite to the second end thereof may be coupled to a direct-current power supply PS2. As illustrated in FIG. 2, the coupling wirings WA (WA1 to WAm) may share their respective portions with each other. In some embodiments, the coupling wirings WA (WA1 to WAm) may be independent of each other and individually coupled to the direct-current power supply PS1. The direct-current power supply PS1 may be provided inside the detector circuitry 100 or outside the detector circuitry 100. Similarly, the direct-current power supply PS2 may be provided inside the detector circuitry 100 or outside the detector circuitry 100.

The coupling wirings WA (WA1 to WAm) may each be provided with corresponding one of switches SWA1 (SWA1-1 to SWA1-m). For example, the coupling wiring WA1 may be provided with the switch SWA1-1; the coupling wiring WA2 may be provided with the switch SWA1-2; and the coupling wiring WAm may be provided with the switch SWA1-m. Further, the coupling wirings WB (WB1 to WBm) may each be provided with corresponding one of switches SWA2 (SWA2-1 to SWA2-m). For example, the coupling wiring WB1 may be provided with the switch SWA2-1; the coupling wiring WB2 may be provided with the switch SWA2-2; and the coupling wiring WBm may be provided with the switch SWA2-m. By setting each of the switches SWA1 (SWA1-1 to SWA1-m) to a conducting state and setting each of the switches SWA2 (SWA2-1 to SWA2-m) to a nonconducting state, a potential of each of the power feeding lines A (A1 to Am) may be set to a first potential V1 by the direct-current power supply PS1. Further, by setting each of the switches SWA1 (SWA1-1 to SWA1-m) to the nonconducting state and setting each of the switches SWA2 (SWA2-1 to SWA2-m) to the conducting state, the potential of each of the power feeding lines A (A1 to Am) may be set to a second potential V2 by the direct-current power supply PS2.

To each of the power feeding lines A, multiple ones of the resistors Z may be coupled at their respective first ends. In the example illustrated in FIG. 2, “n” resistors Z may be coupled in parallel to each of the “m” power feeding lines A. In one example, the resistors Zb(1, 1) and Za(1, 2) to Za(1, n) may be coupled at their respective first ends to the power feeding line A1 extending in the X-axis direction. For example, the power feeding line A1 and the resistor Zb(1, 1) may be coupled to each other at the node P(1, 1). The power feeding line A1 and the resistor Za(1, 2) may be coupled to each other at the node P(1, 2); the power feeding line A1 and the resistor Za(1, 3) may be coupled to each other at the node P(1, 3); and the power feeding line A1 and the resistor Za(1, n) may be coupled to each other at the node P(1, n). Thus, a “j”-th resistor Z from the node P(1, 1) may be coupled to the power feeding line A1 at a “j”-th node P(1, j) from the node P(1, 1).

Similarly, the resistors Zb(2, 1) and Za(2, 2) to Za(2, n) may be coupled at their respective first ends to the power feeding line A2 extending in the X-axis direction. For example, the power feeding line A2 and the resistor Zb(2, 1) may be coupled to each other at the node P(2, 1). The power feeding line A2 and the resistor Za(2, 2) may be coupled to each other at the node P(2, 2); the power feeding line A2 and the resistor Za(2, 3) may be coupled to each other at the node P(2, 3); and the power feeding line A2 and the resistor Za(2, n) may be coupled to each other at the node P(2, n). Thus, a “j”-th resistor Z from the node P(2, 1) may be coupled to the power feeding line A2 at a “j”-th node P(2, j) from the node P(2, 1).

Further, the resistors Zb(m, 1) and Za(m, 2) to Za(m, n) may be coupled at their respective first ends to the power feeding line Am extending in the X-axis direction. For example, the power feeding line Am and the resistor Zb(m, 1) may be coupled to each other at the node P(m, 1). The power feeding line Am and the resistor Za(m, 2) may be coupled to each other at the node P(m, 2); the power feeding line Am and the resistor Za(m, 3) may be coupled to each other at the node P(m, 3); and the power feeding line Am and the resistor Za(m, n) may be coupled to each other at the node P(m, n). Thus, a “j”-th resistor Z from the node P(m, 1) may be coupled to the power feeding line Am at a “j”-th node P(m, j) from the node P(m, 1).

In this way, the resistors Z(i, 1) to Z(i, n) may be coupled at their respective first ends to the power feeding line Ai extending in the X-axis direction. In the example illustrated in FIG. 2, the resistors Z(1, n) to Z(m, n) aligned in the Y-axis direction may be respectively coupled at their first ends to the nodes P(1, n) to P(m, n) that constitute respective second ends of the “m” power feeding lines A opposite to the respective first ends of the “m” power feeding lines A.

### <Power Feeding Line Selector SA>

The power feeding line selector SA may include the switches SWA1 (SWA1-1 to SWA1-m) and the switches SWA2 (SWA2-1 to SWA2-m). The switches SWA1 (SWA1-1 to SWA1-m) and the switches SWA2 (SWA2-1 to SWA2-m) may each be switchable between the conducting state and the nonconducting state. The switches SWA1 (SWA1-1 to SWA1-m) may each be provided on corresponding one of the coupling wirings WA (WA1 to WAm). The switches SWA2 (SWA2-1 to SWA2-m) may each be provided on corresponding one of the coupling wirings WB (WB1 to WBm).

The power feeding line selector SA may select one power feeding line A from the power feeding lines A. For convenience, the one power feeding line A selected from the power feeding lines A will be referred to as a selected power feeding line AS. The power feeding line selector SA may couple the selected power feeding line AS to the direct-current power supply PS1 and couple all of the power feeding lines A other than the selected power feeding line AS to the direct-current power supply PS2. For convenience, the power feeding lines A other than the selected power feeding line AS will each be referred to as an unselected power feeding line AU. A voltage may be applied to the selected power feeding line AS by the direct-current power supply PS1 to set the potential of the selected power feeding line AS to the first potential V1. A voltage may be applied to the unselected power feeding lines AU by the direct-current power supply PS2 to set the potential of each of the unselected power feeding lines AU to the second potential V2. The second potential V2 may be different from the first potential V1. The potential of the selected power feeding line AS may be different from the potential of each of the unselected power feeding lines AU, that is, the second potential V2. Operation of the power feeding line selector SA may be controlled by the control processor 500. For example, the switches SWA1 (SWA1-1 to SWA1-m) and the switches SWA2 (SWA2-1 to SWA2-m) of the power feeding line selector SA may perform their respective switching operations, based on commands from the control processor 500.

### <Control Processor 500>

The control processor 500 may include a microcomputer, for example. The control processor 500 may execute predetermined control processing by causing a central processing unit (CPU) to execute a control program. The control processor 500 may execute control, for example, of the switching operations of the switches SWA1 and SWA2 on the detector circuitry 100.

In one example, the control processor 500 may control switching operations of the power feeding line selector SA. For example, the control processor 500 may set one switch SWA1 corresponding to the selected power feeding line AS to the conducting state and set the other switches SWA1 corresponding to the unselected power feeding lines AU to the nonconducting state. In addition, the control processor 500 may set one switch SWA2 corresponding to the selected power feeding line AS to the nonconducting state and set the other switches SWA2 corresponding to the unselected power feeding lines AU to the conducting state.

Here, ones of the resistors Z that are each selected from the resistors Z and each coupled to both the selected power feeding line AS and corresponding one of the readout lines B will be referred to as selected resistors ZS, for convenience. When one of the power feeding lines A is selected to be the selected power feeding line AS by the power feeding line selector SA based on a command from the control processor 500, a current corresponding to a resistance value of each of the selected resistors ZS may flow through the corresponding one of the readout lines B and may be converted at corresponding one of the first and second converter circuits 201 and 202 of the converter circuitry 200 into a voltage to be outputted from an output terminal T3 of one corresponding operational amplifier OPj out of the operational amplifiers OP.

### <Readout Line B>

The readout lines B may correspond to a specific but non-limiting example of “second wirings” in one embodiment of the disclosure.

The readout lines B (B1 to Bn in FIG. 2) may each be a conductor extending from a node K(1, j) to the operational amplifier OPj. The readout lines B each extend in the second direction different from the first direction. The readout lines B may be arranged adjacent to each other in the first direction different from the second direction. In the example illustrated in FIG. 2, the “n” readout lines B may each extend in the Y-axis direction and may be arranged adjacent to each other in the X-axis direction. The readout line B1 may be a conductor extending from a node K(1, 1) to the operational amplifier OP1. The readout line B2 may be a conductor extending from a node K(1, 2) to the operational amplifier OP2. The readout line B3 may be a conductor extending from a node K(1, 3) to the operational amplifier OP3. The readout line Bn may be a conductor extending from a node K(1, n) to the operational amplifier OPn. Thus, a readout line Bj may be a conductor extending from the node K(1, j) to the operational amplifier OPj.

The readout lines B may each have a first end coupled to a second end of a resistor Z(1, j). The second end of the resistor Z(1, j) may be opposite to the first end thereof coupled to the power feeding line A1. In the example illustrated in FIG. 2, “m” resistors Z may be coupled to each single readout line B. For example, the second end of the resistor Zb(1, 1) may be coupled to the first end of the readout line B1 extending in the Y-axis direction. The readout line B1 and the resistor Zb(1, 1) may be coupled to each other at the node K(1, 1). To the readout line B1, further, the resistor Zb(2, 1) may be coupled at the node K(2, 1) and the resistor Zb(m, 1) may be coupled at the node K(m, 1). Further, the second end of the resistor Za(1, 2) may be coupled to the first end of the readout line B2 extending in the Y-axis direction. The readout line B2 and the resistor Za(1, 2) may be coupled to each other at the node K(1, 2). To the readout line B2, further, the resistor Za(2, 2) may be coupled at the node K(2, 2) and the resistor Za(m, 2) may be coupled at the node K(m, 2). Further, the second end of the resistor Za(1, 3) may be coupled to the first end of the readout line B3 extending in the Y-axis direction. The readout line B3 and the resistor Za(1, 3) may be coupled to each other at the node K(1, 3). To the readout line B3, further, the resistor Za(2, 3) may be coupled at the node K(2, 3) and the resistor Za(m, 3) may be coupled at the node K(m, 3). Further, the second end of the resistor Za(1, n) may be coupled to the first end of the readout line Bn extending in the Y-axis direction. The readout line Bn and the resistor Za(1, n) may be coupled to each other at the node K(1, n). To the readout line Bn, further, the resistor Za(2, n) may be coupled at the node K(2, n) and the resistor Za(m, n) may be coupled at the node K(m, n).

The readout lines B may each have a second end coupled to one corresponding operational amplifier OPj out of the operational amplifiers OP (OP1 to OPn in FIG. 2). The second end of each of the readout lines B may be opposite to the first end thereof coupled to corresponding one of the resistors Zb(1, 1) and Za(1, 2) to Za(1, n). For example, the second end of the readout line B1 may be coupled to a negative input terminal T2 of the operational amplifier OP1; the second end of the readout line B2 may be coupled to the negative input terminal T2 of the operational amplifier OP2; the second end of the readout line B3 may be coupled to the negative input terminal T2 of the operational amplifier OP3; and the second end of the readout line Bn may be coupled to the negative input terminal T2 of the operational amplifier OPn. Through each of the readout lines B, currents may flow that have their respective values corresponding to the respective resistance values of the resistors Z coupled to relevant one of the readout lines B.

### <Resistor Z>

The resistors Z are each coupled to both corresponding one of the power feeding lines A and corresponding one of the readout lines B. The resistors Z may each have the first end coupled to the one of the power feeding lines A and the second end coupled to the one of the readout lines B. As described above, in the example illustrated in FIG. 2, “n” resistors Z may be coupled to each of the power feeding lines A (A1 to Am), and “m” resistors Z may be coupled to each of the readout lines B (B1 to Bn). The number of the resistors Z coupled to both one power feeding line Ai out of the power feeding lines A and one readout line Bj out of the readout lines B may be one. Accordingly, each single resistor Z may be specifiable by selecting one power feeding line Ai from among the power feeding lines A and selecting one readout line Bj from among the readout lines B.

Regarding the “n” resistors Z coupled to the power feeding line A1, in one example, the first end of the resistor Zb(1, 1) may be coupled to the power feeding line A1 at the node P(1, 1), and the second end of the resistor Zb(1, 1) may be coupled to the first end of the readout line B1 at the node K(1, 1). Further, the first end of the resistor Za(1, 2) may be coupled to the power feeding line A1 at the node P(1, 2), and the second end of the resistor Za(1, 2) may be coupled to the first end of the readout line B2 at the node K(1, 2). Further, the first end of the resistor Za(1, 3) may be coupled to the power feeding line A1 at the node P(1, 3), and the second end of the resistor Za(1, 3) may be coupled to the first end of the readout line B3 at the node K(1, 3). Further, the first end of the resistor Za(1, n) may be coupled to the power feeding line A1 at the node P(1, n), and the second end of the resistor Za(1, n) may be coupled to the first end of the readout line Bn at the node K(1, n). This similarly applies to the “n” resistors Z coupled to each of one or more of the power feeding lines A other than the power feeding line A1.

The resistors Z may each be a component of an infrared light receiving device that converts infrared rays condensed by, for example, a lens into an electric signal. In one example, the resistors Z may each include a resistance change layer that exhibits a change in resistance with changing temperature, for example. The resistance change layer may be a thermistor film, for example. The thermistor film may include, for example, vanadium oxide, amorphous silicon, polycrystalline silicon, a manganese-containing oxide having a spinel crystal structure, titanium oxide, or yttrium-barium-copper oxide. In the infrared light receiving device, further, an infrared absorption layer may be provided adjacent to the thermistor film. The infrared absorption layer may absorb infrared rays and generate heat. The infrared absorption layer may include, for example, silicon oxide (SiO₂), aluminum oxide (Al₂O₃), silicon nitride (Si₃N₄), or aluminum nitride (AlN). Temperatures of the infrared absorption layer and the resistance change layer may change with intensity of received infrared rays, and as a result, the resistance change layer of each of the resistors Z may change in resistance value.

In performing measurement on the selected resistors ZS, one of the switches SWA1 that corresponds to the selected power feeding line AS (i.e., one power feeding line A to which the selected resistor ZS is coupled) may be brought into the conducting state to cause a voltage to be applied from the direct-current power supply PS1 to the selected power feeding line AS. Further, in performing the measurement on the selected resistors ZS, a voltage may be applied from the direct-current power supply PS2 to the unselected power feeding lines AU, i.e., all the power feeding lines A except the selected power feeding line AS, through the switches SWA2 that correspond to the respective unselected power feeding lines AU and that are in the conducting state.

By way of example, FIG. 2 illustrates a state where the resistors Z(1, j), that is, the resistors Zb(1, 1) and Za(1, 2) to Za(1, n) are selected to be the selected resistors ZS. In other words, FIG. 2 illustrates a state where the switch SWA1-1 is set to the conducting state to allow a voltage to be applied from the direct-current power supply PS1 to the power feeding line A1 as the selected power feeding line AS corresponding to the resistors Z(1, 1) to Z(1, n) as the selected resistors and to thereby set the potential of the power feeding line A1 to the first potential V1. FIG. 2 further illustrates a state where the switches SWA2-2 to SWA2-m are set to the conducting state to allow a voltage to be applied from the direct-current power supply PS2 to the power feeding lines A2 to Am, i.e., all the unselected power feeding lines AU other than the selected power feeding line A1, and to thereby set the potential of each of the power feeding lines A2 to Am to the second potential V2 different from the first potential V1. In this situation, the switches SWA1-2 to SWA1-m provided in correspondence with the power feeding lines A2 to Am as the unselected power feeding lines AU may all be in the nonconducting state, and the switch SWA2-1 corresponding to the power feeding line A1 as the selected power feeding line AS may also be in the nonconducting state. Note that the first potential V1 and the second potential V2 may be simply different from each other. Either the first potential V1 or the second potential V2 may be 0V.

In the example illustrated in FIG. 2, the resistors Zb coupled to the respective power feeding lines A may be coupled to a single one of the readout lines B. For example, the resistors Zb(1, 1) to Zb(m, 1) respectively coupled to the power feeding lines A1 to Am may all be coupled to the readout line B1.

### <Converter Circuitry 200>

The converter circuitry 200 may include one or more first converter circuits 201 and the second converter circuit 202. In the example illustrated in FIG. 2, the converter circuitry 200 may include multiple first converter circuits 201. In the example illustrated in FIG. 2, the first converter circuits 201 may each include corresponding one of the operational amplifiers OP2 to OPn and corresponding one of the resistors RE2 to REn, and the second converter circuit 202 may include the operational amplifier OP1 and the resistor RE1. The first converter circuits 201 may each convert a first current Ia(i, j) that flows through corresponding one, of the readout lines Bj, to which corresponding resistors Za(i, j) are each coupled, into a first voltage Va(i, j). The first current Ia(i, j) corresponds to the resistance value of each of the corresponding resistors Za(i, j). The first voltage Va(i, j) resulting from the conversion may be outputted to the first amplifier circuit 301. The second converter circuit 202 may convert a second current Ib(i, 1) that flows through corresponding one of the readout lines Bj, i.e., the readout line B1 in the example of FIG. 2, to which the resistors Zb(i, 1) are each coupled, into a second voltage Vb(i, 1). The second current Ib(i, 1) corresponds to the resistance value of each of the resistors Zb(i, 1). The second voltage Vb(i, 1) resulting from the conversion may be outputted to the second amplifier circuit 302.

### <Operational Amplifier OP>

The operational amplifiers OPj (OP1 to OPn in FIG. 2) may each be coupled to one corresponding readout line Bj out of the readout lines B. The operational amplifiers OPj may each include a positive input terminal T1, the negative input terminal T2, and the output terminal T3. The positive input terminal T1 of each of the operational amplifiers OPj may be coupled to, for example, the direct-current power supply PS2 to allow a potential of the positive input terminal T1 of each of the operational amplifiers OPj to be set to the second potential V2 different from the first potential V1. The unselected power feeding lines AU and the positive input terminal T1 of each of the operational amplifiers OPj may thus be set to the same potential, i.e., the second potential V2. The second potential V2 may be 0 V, for example. The negative input terminal T2 of each of the operational amplifiers OPj may be coupled to one corresponding readout line Bj. Each of the operational amplifiers OPj may operate to cause the positive input terminal T1 and the negative input terminal T2 to be at the same potential, and accordingly, the potential of the negative input terminal T2 may become substantially equal to the second potential V2. In each of the operational amplifiers OPj, the output terminal T3 may be coupled to one corresponding negative input terminal T2 through one corresponding resistor REj.

### <Resistor RE>

The resistors RE (RE1 to REn in FIG. 2) may each include a resistor element including, for example, a metal material having a predetermined specific resistance. The resistors RE may each be coupled to both the negative input terminal T2 and the output terminal T3 of one corresponding operational amplifier OPj. Each resistor REj (where j is an integer greater than or equal to two) may convert the first current Ia(i, j) flowing through the readout line Bj coupled to the negative input terminal T2 into the first voltage Va(i, j). The resistor RE1 may convert the second current Ib(i, 1) flowing through the readout line B1 coupled to the negative input terminal T2 into the second voltage Vb(i, 1). For example, in the example illustrated in FIG. 2, the resistor RE1 may be coupled to both the negative input terminal T2 and the output terminal T3 of the operational amplifier OP1, and may convert the second current Ib(i, 1) flowing through the readout line B1 into the second voltage Vb(i, 1). The resistor RE2 may be coupled to both the negative input terminal T2 and the output terminal T3 of the operational amplifier OP2, and may convert the first current Ia(i, 2) flowing through the readout line B2 into the first voltage Va(i, 2). The resistor RE3 may be coupled to both the negative input terminal T2 and the output terminal T3 of the operational amplifier OP3, and may convert the first current Ia(i, 3) flowing through the readout line B3 into the first voltage Va(i, 3). The resistor REn may be coupled to both the negative input terminal T2 and the output terminal T3 of the operational amplifier OPn, and may convert the first current Ia(i, n) flowing through the readout line Bn into the first voltage Va(i, n).

FIG. 3 is a circuit diagram illustrating a circuit configuration example of the amplifier circuitry 300 and the subtractor circuit 400 of the sensor apparatus 1 illustrated in FIG. 1. FIG. 3 also illustrates a circuit configuration example of the converter circuitry 200.

### <Amplifier Circuitry 300>

As illustrated in FIG. 3, the amplifier circuitry 300 may include fixed resistors R2-j (R2-1 to R2-n), variable resistors R3-j (R3-1 to R3-n), and operational amplifiers OP3-j (OP3-1 to OP3-n). Further, the amplifier circuitry 300 may include multiple first amplifier circuits 301 and one second amplifier circuit 302, for example. The first amplifier circuits 301 may each be coupled to corresponding one of the first converter circuits 201. The first amplifier circuits 301 may each include corresponding one of the fixed resistors R2-2 to R2-n, corresponding one of the variable resistors R3-2 to R3-n, and corresponding one of the operational amplifiers OP3-2 to OP3-n. The first amplifier circuits 301 may each amplify the first voltage Va(i, j) from the first converter circuit 201 at a predetermined gain GA based on a ratio between a resistance value of the corresponding one of the fixed resistors R2-2 to R2-n and a resistance value of the corresponding one of the variable resistors R3-2 to R3-n, and may output a first amplified voltage VVa(i, j). Further, switches SWB-2 to SWB-n may be coupled to the respective first amplifier circuits 301. This allows the first amplified voltages VVa(i, 2) to VVa(i, n) corresponding to the respective readout lines B2 to Bn to be selectively outputted to the subtractor circuit 400. The second amplifier circuit 302 may be coupled to the second converter circuit 202. The second amplifier circuit 302 may include a fixed resistor R2-1, a variable resistor R3-1, and an operational amplifier OP3-1. The second amplifier circuit 302 may amplify the second voltage Vb(i, 1) from the second converter circuit 202 at a predetermined gain GB based on a ratio between a resistance value of the fixed resistor R2-1 and a resistance value of the variable resistor R3-1, and may output a second amplified voltage VVb(i, 1).

### <Subtractor Circuit 400>

The subtractor circuit 400 may include an operational amplifier OP400, for example. The subtractor circuit 400 may receive the first amplified voltage VVa(i, j), for example, at a negative input terminal of the operational amplifier OP400, receive the second amplified voltage VVb(i, 1), for example, at a positive input terminal of the operational amplifier OP400, and calculate a difference between the first amplified voltage VVa(i, j) and the second amplified voltage VVb(i, 1).

As illustrated in FIGS. 1 and 3, an analog-to-digital converter circuit ADC may be provided at a stage following the subtractor circuit 400. An output from the operational amplifier OP400 of the subtractor circuit 400 may be converted into a digital signal by the analog-to-digital converter circuit ADC.

### <Preparation of Measurement Operation by Sensor Apparatus 1>

In performing an operation of measuring electromagnetic waves such as infrared rays, the sensor apparatus 1 may perform gain adjustments to respective outputs of the resistors Z through the use of the first amplifier circuits 301 and the second amplifier circuit 302. To perform such gain adjustments, the gain G (GA or GB) corresponding to each of the resistors Z may be determined before performing the operation of measuring the electromagnetic waves. A procedure to determine the gain G will be described below.

### <Determination of Gain G>

First, the sensor apparatus 1 may be placed in a predetermined temperature environment (e.g., an environment at 25° C.). Thereafter, under a condition in which a surface assumable to have a uniform temperature faces the one or more resistors Za(i, j), one or more first voltages Va0(i, j) corresponding to the respective one or more resistors Za(i, j) may be sequentially acquired in the predetermined temperature environment. Note that, for convenience, the above-described one or more first voltages to be acquired under the condition in which the surface assumable to have a uniform temperature faces the one or more resistors Za(i, j) are each denoted as Va0(i, j) for distinction from the first voltages to be acquired in performing the operation of measuring the electromagnetic waves from a measurement target. In addition to the acquisition of the one or more first voltages Va0(i, j), one or more second voltages Vb0(i, 1) resulting from conversion of the respective one or more second currents Ib(i, 1) flowing through corresponding one of the readout lines B, i.e., the readout line B1 in the example of FIG. 2, to which the one or more resistors Zb are each coupled may be sequentially acquired in the predetermined temperature environment. As used herein, the “surface assumable to have a uniform temperature” refers to a surface, of an openable plate-shaped member, such as a shutter, whose overall temperature range (i.e., a difference between a highest temperature and a lowest temperature in the entire surface) falls within a temperature resolution of the sensor apparatus. For example, the overall temperature range of the surface may be 0.05° C. or less. The “uniform temperature” herein may be the same as or different from the ambient temperature (e.g., 25° C.).

In one example, one power feeding line Ai to which the resistors Za(i, j) and Zb(i, 1) targeted for measurement are coupled may be selected by bringing the switch SWA1 of the power feeding line Ai into the conducting state, and a voltage may thus be applied from the direct-current power supply PS1 to the selected power feeding line Ai to set the selected power feeding line Ai to the first potential V1. Remaining ones of the switches SWA1 that correspond to the unselected power feeding lines Ai may be kept in the nonconducting state. Further, ones of the switches SWA2 that correspond to the unselected power feeding lines Ai may be brought into the conducting state and a voltage may thus be applied from the direct-current power supply PS2 to the unselected power feeding lines Ai to set the unselected power feeding lines Ai to the second potential V2. A remaining one of the switches SWA2 that corresponds to the selected power feeding line Ai may be kept in the nonconducting state. FIG. 2 illustrates an example state where the resistors Zb(1, 1) and Za(1, 2) to Za(1, n) are selected. Thus, the power feeding line A1 may be selected by bringing the switch SWA1-1 into the conducting state, and a voltage may thus be applied from the direct-current power supply PS1 to the power feeding line A1. In contrast, the switches SWA1-2 to SWA1-m corresponding to the unselected power feeding lines A2 to Am may be kept in the nonconducting state. Further, the switches SWA2-2 to SWA2-m corresponding to the unselected power feeding lines A2 to Am may be brought into the conducting state, and a voltage may thus be applied from the direct-current power supply PS2 to each of the power feeding lines A2 to Am. In contrast, the switch SWA2-1 corresponding to the selected power feeding line A1 may be kept in the nonconducting state. The negative input terminals T2 of the operational amplifiers OP1 to OPn of the converter circuitry 200 may also be at the second potential V2. This allows a zero voltage to be applied to the resistors Z other than the selected resistors Zb(1, 1) and Za(1, 2) to Za(1, n), thus allowing no current to flow through the resistors Z other than the selected resistors Zb(1, 1) and Za(1, 2) to Za(1, n). A voltage corresponding to a potential difference between the first potential V1 and the second potential V2 may be applied to the selected resistors Zb(1, 1) and Za(1, 2) to Za(1, n). Thus, the first current Ia(1, j) corresponding to the resistance value of each of the resistors Za(1, 2) to Za(1, n) may flow through the readout line Bj, and the second current Ib(1, 1) corresponding to the resistance value of the resistor Zb(1, 1) may flow through the readout line B1.

Thereafter, an output voltage corresponding to each of the selected resistors Za(i, j) and Zb(i, 1) may be acquired. For example, an output voltage may be acquired that corresponds to each of the resistors Za(i, j) and Zb(i, 1) coupled to both the selected power feeding line Ai and corresponding one of the readout lines B and that is outputted from the output terminal T3 of one operational amplifier OP corresponding to the corresponding one of the readout lines B. In the example illustrated in FIG. 2, for example, the second voltage Vb0(1, 1) may be acquired that is outputted from the output terminal T3 of the operational amplifier OP1 corresponding to the resistor Zb(1, 1) coupled to both the power feeding line A1 and the readout line B1. Further, the first voltage Va0(I, 2) may be acquired that is outputted from the output terminal T3 of the operational amplifier OP2 corresponding to the resistor Za(1, 2) coupled to both the power feeding line A1 and the readout line B2. Further, the first voltage Va0(1, 3) may be acquired that is outputted from the output terminal T3 of the operational amplifier OP3 corresponding to the resistor Za(1, 3) coupled to both the power feeding line A1 and the readout line B3. Further, the first voltage Va0(1, n) may be acquired that is outputted from the output terminal T3 of the operational amplifier OPn corresponding to the resistor Za(1, n) coupled to both the power feeding line A1 and the readout line Bn. When any one of the other power feeding lines A2 to Am is selected, the first voltage Va0(i, j) corresponding to each resistor Za(i, j) coupled to the selected one of the power feeding lines A2 to Am and the second voltage Vb0(i, 1) corresponding to the resistor Zb(i, 1) coupled to the selected one of the power feeding lines A2 to Am may each be acquired.

Thereafter, the gain GA corresponding to each of the one or more resistors Za and the gain GB corresponding to each of the one or more resistors Zb may be determined based on the values of the first voltage Va0(i, j) and the second voltage Vb0(i, 1) acquired as above. For example, when the first amplified voltage VVa0(i, j) obtained at the first amplifier circuit 301 is expressed by Equation (1. 1) below and the second amplified voltage VVb0(i, 1) obtained at the second amplifier circuit 302 is expressed by Equation (1. 2) below, the gain GA(i, j) corresponding to each resistor Za(i, j) and the gain GB(i, 1) corresponding to each resistor Zb(i, 1) may be determined to allow, as indicated by Equation (1. 3) below, a difference ΔV0(i, j) between the first amplified voltage VVa0(i, j) and the second amplified voltage VVb0(i, 1) to have a value that falls within a predetermined range for any “i” and any “j”, in other words, to allow the difference ΔV0(i, j) to have a value that falls within a predetermined range and that depends on none of the resistors Za(i, j) and none of the resistors Zb(i, j). Here, it may be ideal that the difference ΔV0(i, j) between the first amplified voltage VVa0(i, j) and the second amplified voltage VVb0(i, 1) fall on a predetermined value Const. that depends on neither “i” nor “j”.

VVa0(i,j)=Va0(i,j)×GA(i,j) (1. 1)

VVb0(i,1)=Vb0(i,1)×GB(i,1) (1. 2)

ΔV0(i,j)=VVa0(i,j)−VVb0(i,1)≈Const. (1. 3)

For example, given that ΔV0(i, j)=0 and GB(i, 1)=α (where α is a constant), the gain GA(i, j) may be expressed by Equation (1. 4) below:

GA(i,j)=α×{Vb0(i,1)/Va0(i,j)} (1. 4).

In this way, the gains GB corresponding to all the resistors Zb(i, 1) in the sensor apparatus 1, that is, the gains GB(1, 1) to GB(m, 1) corresponding to the resistors Zb(1, 1) to Zb(m, 1) may all be set to a common value α, where α is a constant.

For example, given that ΔV0(i, j)=0 and GB(i, 1)=1, the gain GA(i, j) may be expressed by Equation (1. 5) below:

GA(i,j)={Vb0(i,1)/Va0(i,j)} (1. 5).

Because each resistor Za(i, j) and each resistor Zb(i, 1) may be placed at the same ambient temperature, a difference between the first voltage Va0(i, j) and the second voltage Vb0(i, 1) should normally have a value that depends on neither “i” nor “j”. For example, if the temperature of the “surface assumable to have a uniform temperature” facing the one or more resistors Za(i, j) and the ambient temperature are equal, the difference between the first voltage Va0(i, j) and the second voltage Vb0(i, 1) should be zero regardless of “i” and “j”, and if the temperature of the “surface assumable to have a uniform temperature” and the ambient temperature are different from each other, the difference between the first voltage Va0(i, j) and the second voltage Vb0(i, 1) should have a value that is other than zero and dependent on neither “i” nor “j”. In actuality, however, the resistance values of the resistors Z can vary due to individual differences between the resistors Z. The individual differences between the resistors Z may be attributable to, for example, some variations occurring due to a manufacturing error, such as variations in thickness of the resistors Z or variations in distance between two electrodes for supplying voltage to the resistors Z. Given this situation, in order to set the difference between the first amplified voltage VVa0(i, j) and the second amplified voltage VVb0(i, 1) to a predetermined value that depends on neither “i” nor “j” as far as possible, the gains GA for adjusting the first voltages Va0(i, j) corresponding to the resistors Za as what is called active cells may be determined in correspondence with the respective resistors Za with respect to the second voltages Vb0(i, j) corresponding to the resistors Zb(i, 1) as what is called blind cells covered with, for example, the electromagnetic shield 41.

Here, the “predetermined value that depends on neither “i” nor “j”” may be any fixed value determined in advance, and is not limited to a specific value. For example, when the temperature of the “surface assumable to have a uniform temperature” and the ambient temperature are equal, the “predetermined value that depends on neither “i” nor “j”” may be set to zero or to a value other than zero. Further, when the temperature of the “surface assumable to have a uniform temperature” and the ambient temperature are different from each other, the “predetermined value that depends on neither “i” nor “j”” may be set to zero or to a value other than zero.

### <Measurement Operation of Sensor Apparatus 1>

The sensor apparatus 1 may measure output voltages corresponding to the respective resistors Z in the following manner, for example, in a measurement environment in which electromagnetic waves, such as infrared rays, are applied to the sensor apparatus 1. The following measurement operation may be performed in accordance with a command from the control processor 500.

### <Temperature Measurement on Measurement Target>

A description will be given here of a procedure to measure a surface temperature of a measurement target by detecting electromagnetic waves (infrared rays) emitted from the measurement target. Here, the first voltage Va(i, j), the second voltage Vb(i, 1), or both may be amplified at the gain GA, the gain GB, or both that are determined as described above. This helps to achieve increased measurement accuracy.

First, the sensor apparatus 1 may be placed in a predetermined temperature environment (e.g., an environment at 25° C.). Thereafter, under a condition in which the measurement target faces the one or more resistors Za(i, j), the power feeding line Ai (where “i” is within a range from 1 to m both inclusive), for example, may be selected by the power feeding line selector SA and the switch SWB-j (where “j” is within a range from 2 to n both inclusive) for coupling to the subtractor circuit 400 may be brought into the conducting state, in accordance with a command from the control processor 500. As a result, the difference ΔV(i, j) between the first amplified voltage VVa(i, j) and the second amplified voltage VVb(i, 1) is outputtable to the analog-to-digital converter circuit ADC. In performing this operation, for example, the switches SWB-2 to SWB-n may be sequentially brought into the conducting state one by one for the respective power feeding lines Ai to thereby output the differences ΔV(i, 2) to ΔV(i, n) to the analog-to-digital converter circuit ADC. Such an operation may be repeatedly performed for all the power feeding lines A1 to Am.

In the above-described measurement operation, the first voltage Va(i, j) corresponding each of the one or more resistors Za(i, j) may be amplified at the first amplifier circuit 301 at the gain GA determined in advance, and the second voltage Vb(i, 1) resulting from conversion of the second current Ib(i, 1) flowing through one corresponding readout line B (the readout line B1 in the example of FIG. 2), out of the readout lines B, to which the one or more resistors Zb are each coupled may be amplified at the second amplifier circuit 302 at the gain GB determined in advance. The first amplified voltage VVa(i, j) and the second amplified voltage VVb(i, 1) may thus be obtained, as expressed by Equations (2. 1) and (2. 2) below.

VVa(i,j)=Va(i,j)×GA (2. 1)

VVb(i,1)=Vb(i,1)×GB (2. 2)

The subtractor circuit 400 may determine the difference ΔV(i, j) between the first amplified voltage VVa(i, j) and the second amplified voltage VVb(i, 1) as expressed by Equation (2. 3) below. When the difference ΔV(i, j) is of a tiny value, the difference ΔV(i, j) may be amplified at a predetermined gain G.

ΔV(i,j)=(VVa(i,j)−VVb(i,1))×G (2. 3)

In determining the difference ΔV(i, j), the control processor 500 may sequentially bring the switches SWB-2 to SWB-n of the amplifier circuitry 300 into the conducting state one by one to thereby transmit multiple first amplified voltages VVa(i, j) at different timings to the subtractor circuit 400. For example, in calculating the difference ΔV(i, 2), only the switch SWB-2 out of the switches SWB-2 to SWB-n may be brought into the conducting state. In calculating the difference ΔV(i, 3), only the switch SWB-3 out of the switches SWB-2 to SWB-n may be brought into the conducting state. In calculating the difference ΔV(i, n), only the switch SWB-n out of the switches SWB-2 to SWB-n may be brought into the conducting state.

The analog-to-digital converter circuit ADC may convert the difference ΔV(i, j) received from the subtractor circuit 400 into a digital signal indicating the intensity of the infrared rays, and output the digital signal. The surface temperature of the measurement target may be measured through the foregoing operation. When performing measurement on the measurement target, if the difference ΔV(i, j) is equal to the “predetermined value that depends on neither “i” nor “j””, it follows that the temperature of the measurement target is equal to the temperature of the “surface assumable to have an uniform temperature” used in determining the gain. If the difference ΔV(i, j) is different from the “predetermined value that depends on neither “i” nor “j””, it follows that the temperature of the measurement target is calculable from a difference between the difference ΔV(i, j) and the “predetermined value that depends on neither “i” nor “j””.

### <Manufacturing Method of Sensor Apparatus 1>

The sensor apparatus 1 may be configured to, during use after manufacture, determine the gains GA and GB for the respective resistors Z as described above and correct the output voltages corresponding to the respective resistors Z. In some embodiments, the gains GA and GB for the respective resistors Z may be determined in advance during a manufacturing stage of the sensor apparatus 1 in a manner similar to that in the foregoing “Determination of Gain G” as a preparation stage for the foregoing “Temperature Measurement on Measurement Target” in the “Measurement Operation of Sensor Apparatus 1”, and corrections may be made to the output voltages corresponding to the respective resistors Z during use.

For example, first, a structure including the one or more power feeding lines A (A1 to Am), the readout lines B (B1 to Bm), the one or more resistors Za(i, j), and the one or more resistors Zb may be prepared, and the structure may be placed in a predetermined temperature environment (e.g., an environment at 25° C.).

Thereafter, under a condition in which a surface assumable to have a uniform temperature faces the one or more resistors Za(i, j), one or more first voltages Va0(i, j) resulting from conversion of the respective one or more first currents flowing through corresponding one, of the readout lines B (B1 to Bm), to which one or more of the one or more resistors Za(i, j) are coupled may each be measured in the predetermined temperature environment. The definition of the “surface assumable to have a uniform temperature” is as described above under the “Determination of Gain G” section.

Thereafter, one or more second voltages Vb0(i, 1) resulting from conversion of the respective one or more second currents flowing through corresponding one, of the readout lines B (B1 to Bm), to which the one or more resistors Zb are coupled may each be measured in the predetermined temperature environment.

Thereafter, the gain GA corresponding to, out of the one or more resistors Za(i, 1), each of certain one or more resistors Za(i, 1) coupled to one power feeding line Ai out of the one or more power feeding lines A and the gain GB corresponding to, out of the one or more resistors Zb, one resistor Zb coupled to the one power feeding line Ai may be determined, or the gain GA corresponding to each of the certain one or more resistors Za coupled to the one power feeding line Ai may be determined, to allow the difference ΔV0(i, j) between the first amplified voltage VVa0(i, j) and the second voltage Vb0(i, j) corresponding to the one resistor Zb coupled to the one power feeding line Ai, or between the first amplified voltage VVa0(i, j) and the second amplified voltage VVb0(i, 1) to have a value that falls within a predetermined range for any “i” and any “j”. The first amplified voltage VVa0(i, j) results from amplifying the first voltage Va(i, j) corresponding to each of the certain one or more resistors Za coupled to the one power feeding line Ai at the gain GA corresponding to relevant one of the certain one or more resistors Za. The second amplified voltage VVa0(i, j) results from amplifying the second voltage Vb0(i, 1) corresponding to the one resistor Zb coupled to the one power feeding line Ai at the gain GB corresponding to the one resistor Zb.

In the sensor apparatus 1 manufactured as described above, the first voltage Va(i, j) and the second voltage Vb(i, 1) obtained upon performing measurement on the measurement target are amplified at the respective gains GA and GB determined in advance. This allows for outputting each of the first amplified voltage VVa(i, j) and the second amplified voltage VVb(i, 1).

### <Workings and Example Effects of Sensor Apparatus 1>

As described above, the sensor apparatus 1 according to the example embodiment may determine the gain GA corresponding to the resistor Za and the gain GB corresponding to the resistor Zb, based on a ratio between the first voltage Va corresponding to the resistor Za and the second voltage Vb corresponding to the resistor Zb, and may adjust the first voltage Va and the second voltage Vb, based on the gains GA and GB, respectively. This helps to correct variations in characteristic value of the resistor Za caused by some factor such as a manufacturing error. Accordingly, the sensor apparatus 1 helps to achieve high measurement accuracy for a physical quantity targeted for measurement, such as intensity of electromagnetic waves (e.g., infrared rays) applied to the detector circuitry 100, for example. Further, the method of manufacturing the sensor apparatus 1 allows for manufacture of the above-described sensor apparatus.

Further, in the sensor apparatus 1, the resistors Zb coupled to the respective power feeding lines A may all be coupled to a single readout line B (e.g., the readout line B1) out of the readout lines B. Further, the first amplifier circuit 301 for amplifying the first voltage Va(i, j) or the second amplifier circuit 302 for amplifying the second voltage Vb(i. 1) may be coupled to each single readout line B. This helps to individually perform amplification of the first voltage Va(i, j) at the first amplifier circuit 301 and amplification of the second voltage Vb(i, 1) at the second amplifier circuit 302 and to thereafter calculate the difference between the first amplified voltage VVa(i, j) and the second amplified voltage VVb(i, 1).

Further, according to the sensor apparatus 1, the first voltage Va(i, j) and the second voltage Vb(i, 1) are respectively expressible by Equations (3. 1) and (3. 2) below:

Va(i,j)=RREj×(V2−V1)/R(i,j) (3. 1)

Vb(i,1)=RRE1=(V2−V1)/R(i,1) (3. 2)

where R(i, j) represents the resistance value of the resistor Z(i, j), and RREj represents the resistance value of the resistor REj.

Here, for example, when the resistor Z is a thermistor, the resistance value R(i, j) of the resistor Z(i, j) may be given as follows:

R(i,j)=R0(i,j)×exp{β×(1/T−1/T0)} (3. 3)

where δ represents a B constant of the thermistor, T represents temperature, TO represents a reference temperature, and R0(i, j) represents the resistance value of the resistor Z(i, j) at the reference temperature.

Thus, the following equations may hold.

Va(i,j)={RREj×(V2−V1)/R0(i,j)}×1/exp{×(1/T×1/T0)} (3. 4. 1)

Vb(i,1)={RRE1×(V2−V1)/R0(i,1)}×1/exp{3×(1/T−1/T0)} (3. 4. 2)

Variations in thickness of the resistor Z and variations in distance between the two electrodes for supplying voltage to the resistor Z may manifest in variations in the value of R0(i, j) in Equation (3. 4. 1) above and variations in the value of R0(i, 1) in Equation (3. 4. 2) above.

In the sensor apparatus 1 according to the example embodiment, the gain GA(i, j) and the gain GB(i, 1) each corresponding to corresponding one of the resistors Z may be so determined as to suppress an effect of variations between the resistors Z in the value of R0(i, j), based on the first voltage Va0(i, j) acquired at a predetermined ambient temperature under the condition in which the surface assumable to have a uniform temperature faces the resistor Za(i, j), and the second voltage Vb0(i, 1) acquired at the predetermined ambient temperature. Further, in the sensor apparatus 1 according to the example embodiment, the first voltage Va and the second voltage Vb may be adjusted using the gain GA(i, j) and the gain GB(i, 1) determined as above to thereby obtain the first amplified voltage VVa(i, j) and the second amplified voltage VVb(i, 1) that are expressible by Equations (3. 5) and (3. 6) below.

VVa(i,j)=Va(i,j)×GA(i,j)

={RREj×(V2−V1)×GA(i,j)/R0(i,j)}×1/exp{3×(/T−1/T0)} (3. 5)

VVb(i,1)=Vb(i,1)×GB(i,1)

={RRE1×(V2−V1)×GB(i,1)/R0(i,1)}×1/exp{β×(/T−1/T0)} (3. 6)

The sensor apparatus 1 according to the example embodiment helps to suppress variations in the value of “GA(i, j)/R0(i, j)” in Equation (3. 5) above and variations in the value of “GB(i, 1)/R0(i, 1)” in Equation (3. 6) above. The value of R0(i, j) does not depend on the ambident temperature at which the first voltage Va0(i, j) for determining the gain GA(i, j) and the second voltage Vb0(i, 1) for determining the gain GB(i, 1) are acquired. Accordingly, as long as the first and second voltages Va0(i, j) and Vb0(i, 1) corresponding to multiple resistors Z are acquired at the same ambient temperature, the gains GA(i, j) and GB(i, 1) are so determinable as to suppress variations in the value of “GA(i, j)/R0(i, j)” and variations in the value of “GB(i, 1)/R0(i, 1)”, regardless of the value of the ambient temperature at which the first and second voltages Va0(i, j) and Vb0(i, 1) are acquired. In other words, even if the operation of measuring electromagnetic waves is performed at an ambient temperature that has become different relative to that at which the first and second voltages Va0(i, j) and Vb0(i, 1) for determining the gains GA(i, j) and GB(i, 1) have been acquired, the sensor apparatus 1 helps to suppress an effect of variations in characteristic value of the resistors Z, which can result from a factor such as a manufacturing error, on the first amplified voltage VVa(i, j) and the second amplified voltage VVb(i, 1), as with a case of performing the measurement operation at the same ambient temperature as that at which the first and second voltages Va0(i, j) and Vb0(i, 1) have been acquired. This helps to achieve high measurement accuracy for intensity of electromagnetic waves, such as infrared rays.

### 2. Modification Examples

Although some example embodiments of the disclosure have been described hereinabove, the disclosure is not limited to such example embodiments, and may be modified in a variety of ways.

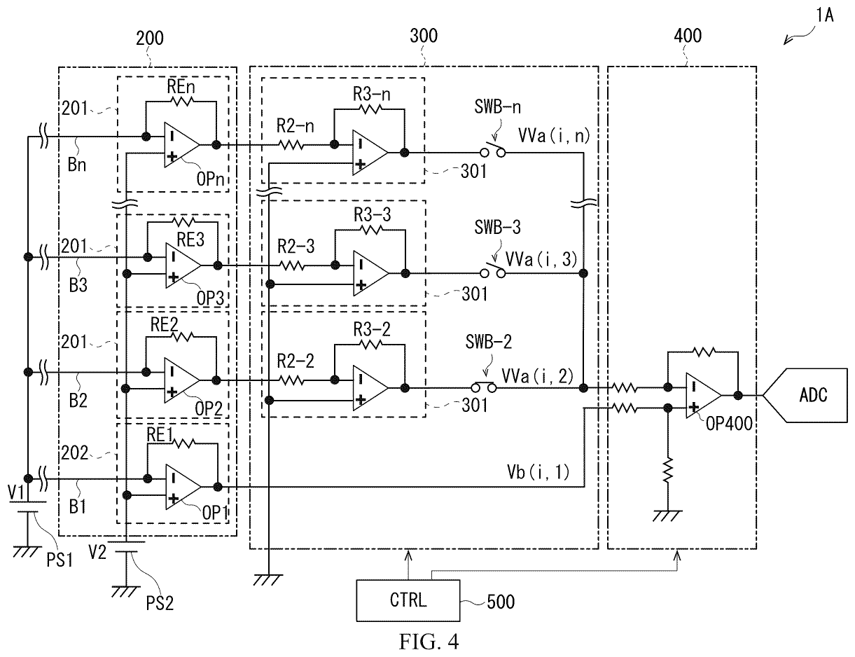

For example, in the sensor apparatus 1 according to the foregoing example embodiment, as illustrated in FIG. 3, the amplifier circuitry 300 may include both the first amplifier circuit 301 and the second amplifier circuit 302; however, any embodiment of the disclosure is not limited thereto. For example, in some embodiments where the gains GB(1, 1) to GB(m, 1) for the resistors Zb(1, 1) to Zb(m, 1) are all to be set to 1, the second voltages (i, j) may not have to be amplified. The second amplifier circuit 302 may thus be omitted from the amplifier circuitry 300, as in a sensor apparatus 1A according to a first modification example illustrated in FIG. 4, for example. In such a case, the subtractor circuit 400 may calculate and output a difference between the first amplified voltage VVa(i. j) and the second voltage Vb(i. 1).

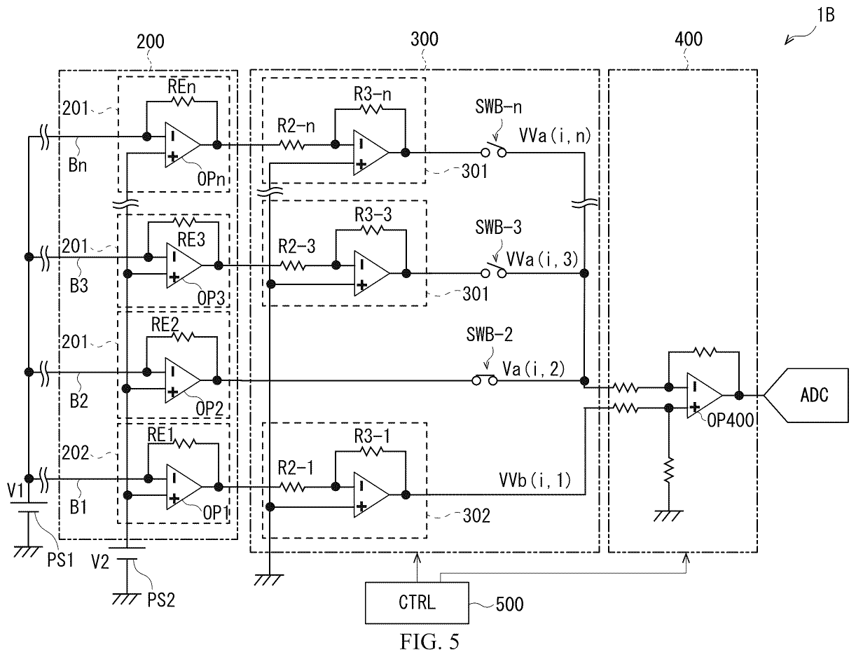

Further, in the sensor apparatus 1 according to the foregoing example embodiment, the gains GA may be determined with respect to the gains GB for the resistors Zb(i, 1) as blind cells covered with the electromagnetic shield 41; however, any embodiment of the disclosure is not limited thereto. In some embodiments, the gains GA and GB may be determined with respect to the resistors Za(i, 2) as active cells coupled to one of the readout lines B, e.g., the readout line B2. For example, in a case where the gains GA(1, 2) to GA(m, 2) for the resistors Za(1, 2) to Za(m, 2) are all to be set to 1, the first voltages Va(i, 2) may not have to be amplified. The first amplifier circuit 301 corresponding to the readout line B2 may thus be omitted from the amplifier circuitry 300, as in a sensor apparatus 1B according to a second modification example illustrated in FIG. 5, for example.

In the sensor apparatus 1B illustrated in FIG. 5, the gain GB may be determined in the following manner, for example. First, the sensor apparatus 1B may be placed in a predetermined temperature environment (e.g., an environment at 25° C.). Thereafter, under a condition in which a surface assumable to have a uniform temperature faces the one or more resistors Za(i, j), one or more first voltages Va0(i, j) corresponding to the respective one or more resistors Za(i, j) may be sequentially acquired in the predetermined temperature environment. In addition to the acquisition of the one or more first voltages Va0(i, j), one or more second voltages Vb0(i, 1) resulting from conversion of the respective one or more second currents Ib(i, 1) flowing through corresponding one of the readout lines B, i.e., the readout line B1 in the example of FIG. 5, to which the one or more resistors Zb are each coupled may be sequentially acquired in the predetermined temperature environment.

In one example, an output voltage may be acquired that corresponds to each of the resistors Za(i, j) and Zb(i, 1) selected by the switches SWA1 and SWA2. For example, an output voltage may be acquired that corresponds to each of the resistors Za(i, j) and Zb(i, 1) coupled to both the selected power feeding line Ai and corresponding one of the readout lines B and that is outputted from the output terminal T3 of one operational amplifier OP corresponding to the corresponding one of the readout lines B. For example, the second voltage Vb0(1, 1) may be acquired that is outputted from the output terminal T3 of the operational amplifier OP1 corresponding to the resistor Zb(1, 1) coupled to both the power feeding line A1 and the readout line B1. Further, the first voltage Va0(1, 2) may be acquired that is outputted from the output terminal T3 of the operational amplifier OP2 corresponding to the resistor Za(1, 2) coupled to both the power feeding line A1 and the readout line B2. Further, the first voltage Va0(1, 3) may be acquired that is outputted from the output terminal T3 of the operational amplifier OP3 corresponding to the resistor Za(1, 3) coupled to both the power feeding line A1 and the readout line B3. Further, the first voltage Va0(1, n) may be acquired that is outputted from the output terminal T3 of the operational amplifier OPn corresponding to the resistor Za(1, n) coupled to both the power feeding line A1 and the readout line Bn. When any one of the other power feeding lines A2 to Am is selected, the first voltage Va0(i, j) corresponding to the resistor Za(i, j) coupled to the selected one of the power feeding lines A2 to Am and the second voltage Vb0(i, 1) corresponding to the resistor Zb(i, 1) coupled to the selected one of the power feeding lines A2 to Am may each be acquired.

Thereafter, the gain GB corresponding to each of the one or more resistors Zb may be determined based on the values of the first voltage Va0(i, 2) and the second voltage Vb0(i, 1) acquired as above. For example, the gain GB(i, 1) corresponding to each resistor Zb(i, 1) may be determined to allow a difference ΔV0(i, 2) between the first voltage Va0(i, 2) and the second amplified voltage VVb0(i, 1) obtained at the second amplifier circuit 302 to have a value that falls within a predetermined range for any “i”. In other words, the gain GB(i, 1) corresponding to each resistor Zb(i, 1) may be determined to allow the difference ΔV0(i, 2) to have a value that falls within a predetermined range and that depends on none of the resistors Za(i, j) and none of the resistors Zb(i, j). Here, it may be ideal that the difference ΔV0(i, 2) between the first voltage Va0(i, 2) and the second amplified voltage VVb0(i, 1) fall on a predetermined value Const. that does not depend on “i”.

Further, the gain GA(i, j) (where j≥3) corresponding to each resistor Za(i, j) may be determined to allow a difference ΔV0(i, j) between the first amplified voltage VVa0(i, j) obtained at the first amplifier circuit 301 and the second amplified voltage VVb0(i, 1) obtained at the second amplifier circuit 302 to have a value that falls within a predetermined range for any “i” and any “j”. In other words, the gain GA(i, j) (where j≥3) corresponding to each resistor Za(i, j) may be determined to allow the difference ΔV0(i, j) to have a value that falls within a predetermined range and that depends on none of the resistors Za(i, j) and none of the resistors Zb(i, j). Here, it may be ideal that the difference ΔV0(i, j) between the first amplified voltage VVa0(i, j) and the second amplified voltage VVb0(i, 1) fall on a predetermined value Const. that depends on neither “i” nor “j”.

In some embodiments where the readout line B2 is the only readout line B to which the resistors Za are coupled, the first amplifier circuits 301 may be omitted from the amplifier circuitry 300. In such a case, the gain GB(i, 1) corresponding to each resistor Zb(i, 1) may be determined to allow a difference between the first voltage Va0(i, 2) and the second amplified voltage VVb0(i, 1) to have a value that falls within a predetermined range for any “i”. For the sensor apparatus in which the readout line B2 is the only readout line B to which the resistors Za are coupled, the gain GB may be determined by using a procedure similar to the procedure of determining the gain GB in the sensor apparatus 1B illustrated in FIG. 5.

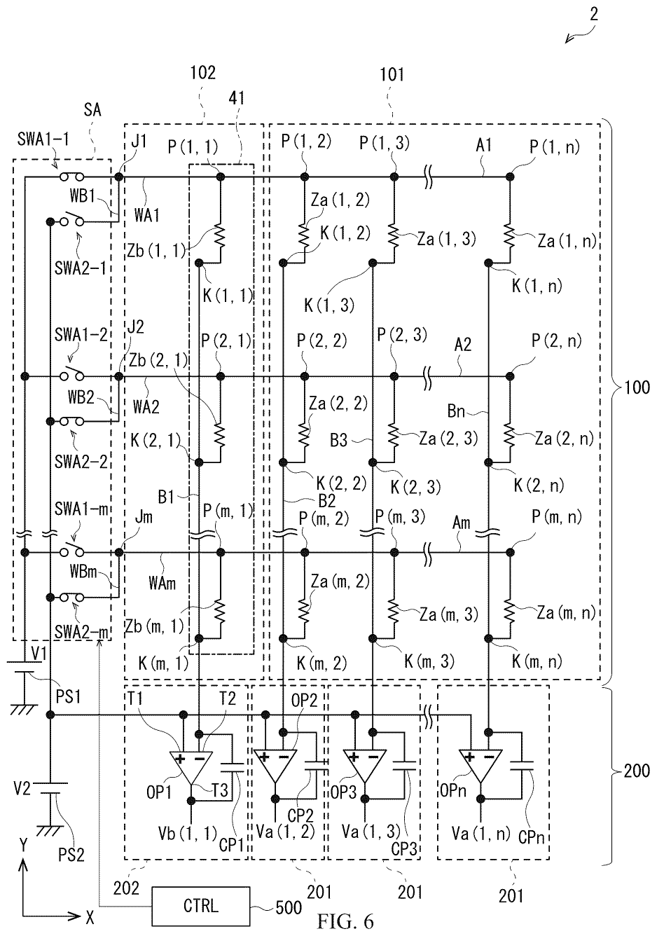

In the sensor apparatus 1 according to the foregoing example embodiment, the converter circuitry 200 may include the multiple resistors RE (RE1 to REn); however, any embodiment of the disclosure is not limited thereto. In some embodiments, as in a sensor apparatus 2 illustrated in FIG. 6, multiple capacitors CP (CP1 to CPn) may be provided, instead of the resistors RE (RE1 to REn), in correspondence with the multiple operational amplifiers OP (OP1 to OPn). The capacitors CP may each be coupled to both the negative input terminal T2 and the output terminal T3 of corresponding one of the operational amplifiers OP, and may each convert a current flowing through the readout line B coupled to the negative input terminal T2 into a voltage. For example, in the example illustrated in FIG. 6, the capacitor CP1 may be coupled to both the negative input terminal T2 and the output terminal T3 of the operational amplifier OP1, and may convert a current flowing through the readout line B1 into a voltage. Similarly, the capacitor CP2 may be coupled to both the negative input terminal T2 and the output terminal T3 of the operational amplifier OP2, and may convert a current flowing through the readout line B2 into a voltage. The capacitor CP3 may be coupled to both the negative input terminal T2 and the output terminal T3 of the operational amplifier OP3, and may convert a current flowing through the readout line B3 into a voltage. The capacitor CPn may be coupled to both the negative input terminal T2 and the output terminal T3 of the operational amplifier OPn, and may convert a current flowing through the readout line Bn into a voltage.

As described above, although the converter circuitry 200 may include the multiple resistors RE in the sensor apparatus 1 according to the foregoing example embodiment, any embodiment of the disclosure is not limited thereto. In some embodiments, multiple diodes may be provided instead of the resistors RE. In such a case, the currents flowing through the respective readout lines may be converted into voltages by the respective diodes in accordance with respective current-voltage characteristics of the diodes.

The sensor apparatus 1 according to the foregoing example embodiment may include the resistors Z as the first and second impedance elements; however, the sensor apparatus according to any embodiment of the disclosure is not limited thereto. In some embodiments, the resistors Z in the sensor apparatus may be replaced with semiconductor elements, such as diodes, whose electrical properties change with temperature.

The sensor apparatus 1 according to the foregoing example embodiment may include multiple power feeding lines A as the first wirings; however, any embodiment of the disclosure is not limited thereto. In some embodiments, the sensor apparatus may include a single first wiring.

The disclosure encompasses any possible combination of some or all of the various embodiments and the modification examples described herein and incorporated herein.

The sensor apparatus according to at least one embodiment of the disclosure makes it possible to correct variations in characteristic value of each of the first impedance element and the second impedance element caused by some factor such as a manufacturing error, through the use of the first voltage corresponding to the first impedance element and the second voltage corresponding to the second impedance element. The sensor apparatus according to at least one embodiment of the disclosure thus makes it possible to achieve high measurement accuracy for a physical quantity targeted for measurement.

Each of the methods of manufacturing first to third sensor apparatuses according to at least one embodiment of the disclosure makes it possible to manufacture the above-described sensor apparatus.

It is to be noted that the effects described herein are mere examples and non-limiting, and other effects may be achieved.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is:

1. A sensor apparatus comprising:
one or more first wirings;
second wirings each extending in a direction different from a direction in which the one or more first wirings each extend;
one or more first impedance elements each coupled to both corresponding one of the one or more first wirings and corresponding one of the second wirings;
one or more second impedance elements each coupled to both corresponding one of the one or more first wirings and corresponding one of the second wirings;
one or more first converter circuits each configured to convert a first current into a first voltage, the first current flowing through corresponding one, of the second wirings, to which one or more of the one or more first impedance elements are each coupled;
a second converter circuit configured to convert a second current into a second voltage, the second current flowing through corresponding one, of the second wirings, to which the one or more second impedance elements are each coupled;
one or more first amplifier circuits, a second amplifier circuit, or both, the one or more first amplifier circuits each being configured to output a first amplified voltage resulting from amplifying the first voltage corresponding to each of corresponding one or more first impedance elements, out of the one or more first impedance elements, at a first gain corresponding to relevant one of the corresponding one or more first impedance elements, the second amplifier circuit being configured to output a second amplified voltage resulting from amplifying the second voltage corresponding to each of the one or more second impedance elements at a second gain corresponding to relevant one of the one or more second impedance elements; and
a subtractor circuit configured to output at least one of a difference between the first amplified voltage and the second amplified voltage, a difference between the first amplified voltage and the second voltage, or a difference between the first voltage and the second amplified voltage.

2. The sensor apparatus according to claim 1, further comprising an electromagnetic shield covering the one or more second impedance elements.

3. The sensor apparatus according to claim 1, wherein
the one or more first wirings comprise a plurality of the first wirings,
the one or more first impedance elements comprise a plurality of the first impedance elements,
the one or more second impedance elements comprise a plurality of the second impedance elements, and
the second impedance elements coupled to the first wirings are coupled to one of the second wirings.

4. The sensor apparatus according to claim 3, wherein
the sensor apparatus comprises both the one or more first amplifier circuits and the second amplifier circuit,
the second amplifier circuit is configured to output the second amplified voltage resulting from amplifying the second voltage corresponding to each of the second impedance elements at the second gain common to the second impedance elements.

5. The sensor apparatus according to claim 1, wherein the sensor apparatus comprises the one or more first amplifier circuits, without the second amplifier circuit.

6. The sensor apparatus according to claim 1, wherein the sensor apparatus comprises the second amplifier circuit, without the one or more first amplifier circuits.

7. The sensor apparatus according to claim 2, further comprising
a control processor,
the control processor being configured to:
measure the first voltage corresponding to each of the one or more first impedance elements at a predetermined ambient temperature under a condition in which a surface assumable to have a uniform temperature faces the one or more first impedance elements;
measure the second voltage corresponding to each of the one or more second impedance elements at the predetermined ambient temperature; and
determine the first gain and the second gain, or determine the first gain, the first gain corresponding to, out of the one or more first impedance elements, each of certain one or more first impedance elements coupled to one first wiring out of the one or more first wirings, the second gain corresponding to, out of the one or more second impedance elements, one second impedance element coupled to the one first wiring, to allow the difference between the first amplified voltage and the second voltage or the difference between the first amplified voltage and the second amplified voltage to have a value that falls within a predetermined range and that depends on none of the one or more first impedance elements and none of the one or more second impedance elements, where the first amplified voltage is based on the first voltage corresponding to each of the certain one or more first impedance elements coupled to the one first wiring, the second voltage corresponds to the one second impedance element coupled to the one first wiring, and the second amplified voltage is based on the second voltage corresponding to the one second impedance element coupled to the one first wiring.

8. The sensor apparatus according to claim 2, further comprising
a control processor,
the control processor being configured to:
measure the first voltage corresponding to each of the one or more first impedance elements at a predetermined ambient temperature under a condition in which a surface assumable to have a uniform temperature faces the one or more first impedance elements;
measure the second voltage corresponding to each of the one or more second impedance elements at the predetermined ambient temperature; and
determine the second gain corresponding to, out of the one or more second impedance elements, one second impedance element coupled to one first wiring out of the one or more first wirings, to allow the difference between the first voltage and the second amplified voltage to have a value that falls within a predetermined range and that depends on none of the one or more first impedance elements and none of the one or more second impedance elements, where the first voltage corresponds to, out of the one or more first impedance elements, each of certain one or more first impedance elements coupled to the one first wiring out of the one or more first wirings, and the second amplified voltage is based on the second voltage corresponding to the one second impedance element coupled to the one first wiring.

9. The sensor apparatus according to claim 2, wherein
the sensor apparatus comprises both the one or more first amplifier circuits and the second amplifier circuit,
the one or more first impedance elements comprise a plurality of the first impedance elements,
at least one of the first impedance elements is coupled to each of two or more second wirings out of the second wirings,
the one or more first amplifier circuits are coupled to one or more second wirings, out of the second wirings, that are other than one of the two or more second wirings,
the second amplifier circuit is coupled to one or more second wirings, out of the second wirings, to which the one or more second impedance elements are coupled.

10. The sensor apparatus according to claim 9, further comprising
a control processor,
the control processor being configured to:
measure the first voltage corresponding to each of the one or more first impedance elements at a predetermined ambient temperature under a condition in which a surface assumable to have a uniform temperature faces the one or more first impedance elements;
measure the second voltage corresponding to each of the one or more second impedance elements at the predetermined ambient temperature; and
determine the second gain corresponding to, out of the one or more second impedance elements, one second impedance element coupled to one first wiring out of the one or more first wirings, to allow the difference between the first voltage and the second amplified voltage to have a value that falls within a predetermined range and that depends on none of the one or more first impedance elements and none of the one or more second impedance elements, where the first voltage corresponds to, out of the one or more first impedance elements, one first impedance element coupled to the one first wiring and coupled to one second wiring, out of the second wirings, to which the one or more first amplifier circuits are not coupled, and the second amplified voltage is based on the second voltage corresponding to the one second impedance element coupled to the one first wiring; and
determine the first gain corresponding to, out of the one or more first impedance elements, each of certain one or more first impedance elements coupled to the one first wiring and coupled to the one or more first amplifier circuits via corresponding one or more of the second wirings, to allow the difference between the first amplified voltage and the second amplified voltage to have a value that falls within a predetermined range and that depends on none of the one or more first impedance elements and none of the one or more second impedance elements, where the first amplified voltage is based on the first voltage corresponding to each of the certain one or more first impedance elements coupled to the one first wiring and coupled to the one or more first amplifier circuits via the corresponding one or more of the second wirings, and the second amplified voltage is based on the second voltage corresponding to the one second impedance element coupled to the one first wiring.

11. A method of manufacturing a sensor apparatus, comprising:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled; and
determining a first gain and a second gain, or determining the first gain, the first gain corresponding to, out of the one or more first impedance elements, each of certain one or more first impedance elements coupled to one first wiring out of the one or more first wirings, the second gain corresponding to, out of the one or more second impedance elements, one second impedance element coupled to the one first wiring, to allow a difference between a first amplified voltage and the second voltage or a difference between the first amplified voltage and a second amplified voltage to have a value that falls within a predetermined range and that depends on none of the one or more first impedance elements and none of the one or more second impedance elements, where the first amplified voltage results from amplifying the first voltage corresponding to each of the certain one or more first impedance elements coupled to the one first wiring at the first gain corresponding to relevant one of the certain one or more first impedance elements, the second voltage corresponds to the one second impedance element coupled to the one first wiring, and the second amplified voltage results from amplifying the second voltage corresponding to the one second impedance element coupled to the one first wiring at the second gain corresponding to the one second impedance element.

12. A method of manufacturing a sensor apparatus, comprising:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled; and
determining a second gain corresponding to, out of the one or more second impedance elements, one second impedance element coupled to one first wiring out of the one or more first wirings, to allow a difference between the first voltage and a second amplified voltage to have a value that falls within a predetermined range and that depends on none of the one or more first impedance elements and none of the one or more second impedance elements, where the first voltage corresponds to, out of the one or more first impedance elements, each of certain one or more first impedance elements coupled to the one first wiring out of the one or more first wirings, and the second amplified voltage results from amplifying the second voltage corresponding to the one second impedance element coupled to the one first wiring at the second gain corresponding to the one second impedance element.

13. A method of manufacturing a sensor apparatus, comprising:
preparing a structure, the structure including one or more first wirings, second wirings each extending in a direction different from a direction in which the one or more first wirings each extend, one or more first impedance elements each coupled to both corresponding one of the one or more first wirings and corresponding one of the second wirings, and one or more second impedance elements each coupled to both corresponding one of the one or more first wirings and corresponding one of the second wirings,
measuring a first voltage corresponding to each of the one or more first impedance elements at a predetermined ambient temperature under a condition in which a surface assumable to have a uniform temperature faces the one or more first impedance elements, the first voltage resulting from conversion of a first current flowing through corresponding one, of the second wirings, to which one or more of the one or more first impedance elements are each coupled;
measuring a second voltage corresponding to each of the one or more second impedance elements at the predetermined ambient temperature, the second voltage resulting from conversion of a second current flowing through corresponding one, of the second wirings, to which the one or more second impedance elements are each coupled;
determining a second gain corresponding to, out of the one or more second impedance elements, one second impedance element coupled to one first wiring out of the one or more first wirings, to allow a difference between the first voltage and a second amplified voltage to have a value that falls within a predetermined range and that depends on none of the one or more first impedance elements and none of the one or more second impedance elements, where the first voltage corresponds to, out of the one or more first impedance elements, one first impedance element coupled to the one first wiring and coupled to one second wiring out of the second wirings, and the second amplified voltage results from amplifying the second voltage corresponding to the one second impedance element coupled to the one first wiring at the second gain corresponding to the one second impedance element; and
determining a first gain corresponding to, out of the one or more first impedance elements, each of certain one or more first impedance elements coupled to the one first wiring and coupled to one or more of the second wirings other than the one second wiring, to allow a difference between a first amplified voltage and the second amplified voltage to have a value that falls within a predetermined range and that depends on none of the one or more first impedance elements and none of the one or more second impedance elements, where the first amplified voltage results from amplifying the first voltage corresponding to each of the certain one or more first impedance elements coupled to the one first wiring and coupled to the one or more of the second wirings other than the one second wiring at the first gain corresponding to relevant one of the certain one or more first impedance elements, and the second amplified voltage is based on the second voltage corresponding to the one second impedance element coupled to the one first wiring.
